(19) United States
(12) Patent Application Publication
(10) Pub. No.: US 2011/0054948 A1
(43) Pub. Date: Mar. 3, 2011

(54) FIDUCIARY CASH FLOW DATA MANAGEMENT

(75) Inventors: Ajalesh P. GOPI, Kozhikode (IN); Srivijaya GUTALA, Bangalore (IN); Mathias SONNEK, Oberhausen-Rheinhausen (DE); Klaus Guenter MUELLER, Neustadt (DE); Sujay V. KOPARDE, Bangalore (IN); Ashish BANSAL, Delhi (IN); Julia SCHAEFER, Mannheim (DE)

(73) Assignee: SAP AG, Walldorf (DE)

(21) Appl. No.: 12/550,757

(22) Filed: Aug. 31, 2009

(51) Int. Cl. G06Q 40/00

(52) U.S. Cl. 705/4

(57) ABSTRACT

In an embodiment, a fiduciary deposit business object may be used to manage data relating to cash flow instruments. The business object may be structured in an embodiment to include a plurality of tables, including transaction, collateral, activity, cash flow, and/or adjustment tables. In an embodiment, when a settlement activity is recorded in the business object, a financial calculation procedure may be initiated. The financial calculation procedure may use data stored in the tables in a financial calculation, such as a gain/loss calculation, based on the location of the data in a specific table, such as whether the data was recently added. After completing the financial calculation, data in the business object may be updated and/or a result may be sent to an accounting system. Additional data, such as data in the collateral and other tables, may also be sent to the accounting system depending on accounting reporting requirements.

### BACKGROUND

Insurance companies often are required to comply with different regulatory requirements depending on the locality and insurance product being offered. For example, in Spain, regulations require insurance companies to match asset and liability cash flows for certain insurance products related to pensions. To comply with these regulations, insurance companies may engage in additional financial transactions with counterparties such as banks or other financial entities in a fiduciary capacity.

For example, when an insurance company receives an insurance premium from a customer that is subsequently invested by the insurance company, regulations may require the insurance company to show a corresponding asset in its balance sheet matching the premium. To show an asset, the insurance company may enter into an agreement with the counterparty, where the insurance company provides the counterparty with an initial payment and the counterparty agrees to pay a periodic fixed cash flow to the insurance company. The cash flow paid by the counterparty to the insurance company may comprise two components, a repayment component and an interest component.

Existing computing systems, such as enterprise resource planning systems, have not been designed or configured to process, manage, and properly account for counterparty payments in an insurance context. Because these systems have not been designed to account for these counterparty payments, compliance with insurance regulations had to be determined through cumbersome and inefficient manual calculations. Moreover, any changes to insurance premiums or the terms of insurance policies would also necessitate further recalculations.

There is thus a need for efficient systems and methods for automatically processing, managing, and properly accounting for counterparty payments in an insurance context.

### BRIEF DESCRIPTION OF THE DRAWINGS

FIG. 1 shows a graphical representation of data associated with the fiduciary deposit business object in an embodiment.

FIG. 2 shows a data structure of a fiduciary deposit business object in an embodiment.

FIG. 3 shows the automated flow of data in an embodiment.

FIG. 4 shows an embodiment of an enterprise resource planning system.

### DETAILED DESCRIPTION

In an embodiment, a fiduciary deposit business object may be created in a computer system to represent cash flow-based instruments between the counterparty and the insurance company. In an embodiment, the fiduciary deposit object may include data or links to data identifying the collateral supporting the cash flow instruments, the monthly cash flows received by the insurance company, the principal paid to counterparty, and the terms of the cash flow agreement. In an embodiment, data from fiduciary deposit object may be sent to an accounting system where appropriate balance sheet entries or adjustments can be made automatically.

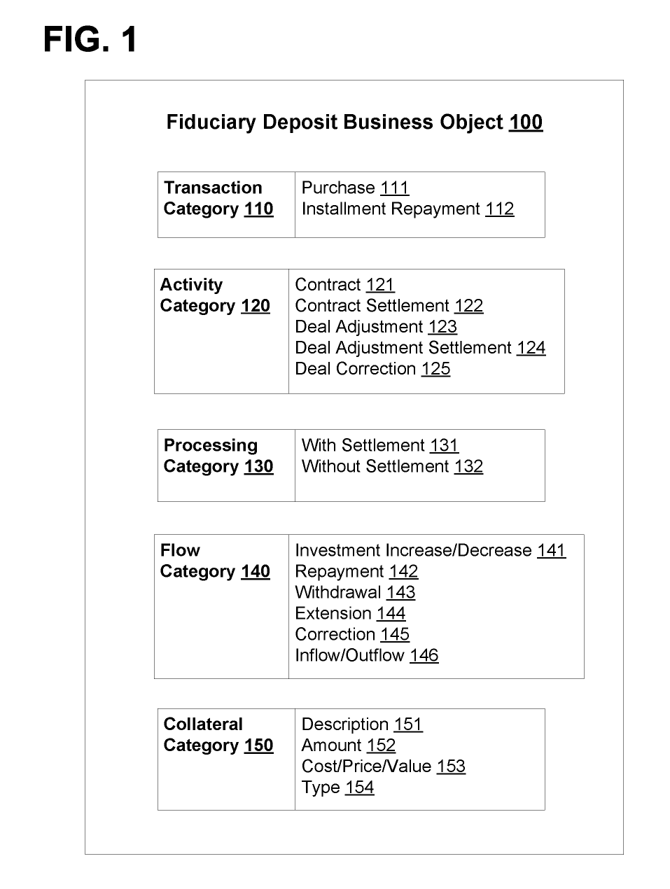

FIG. 1 shows a graphical representation of data associated with the fiduciary deposit business object 100 in an embodiment of the invention. In an embodiment, the fiduciary deposit object 100 may have a one or more transaction categories 110 associated with the business object 100. A transaction category may store a description or identifier of a financial transaction pertaining to a cash flow-based instrument. The transaction categories 110 may include an identifier or description of transactions such as a purchase 111, which may contain an initial investment by insurance company to the counterparty, and an installment repayment 112, which may contain the monthly cash flow received by the insurance company from the counterparty.

Each transaction category 110 may have one or more activity categories 120 associated with transaction. An activity category may store a description or identifier of an action taken pertaining to an agreement involving a transaction of the cash flow-based instrument. Thus, for example, the purchase transaction 111 may have activities such as contract 121, deal adjustment 123, contract settlement 122, deal adjustment settlement 124, deal correction 125, and deal correction settlement 126 associated with the transaction. A user may select an activity, such as deal adjustment 123, to enter and/or store data reflecting a change in the terms of an agreement with the counterparty, such as extending the length of the agreement and the cash flow payments, or withdrawing the agreement. The deal correction 125 activity may be used to enter and/or store data correcting an agreement term. The contract 121 activity may be used to enter and/or store the original terms of agreement relating to a fiduciary deposit. The settlement activities, including contract settlement 122, deal adjustment settlement 124, and deal correction settlement 126 may be used when the respective agreement terms, deal adjustment terms, and deal correction terms have been agreed to by the parties. In other situations the contract 121, deal adjustment 123, and deal correction 125 activities may be used.

In an embodiment, the fiduciary deposit object 100 may also have processing categories 130 associated with the object, such as with settlement 131 and without settlement 132. A processing category may store a description or identifier of whether an activity may be changed unilaterally or only after some type of agreement is reached between the parties. In cases where the ‘without settlement’ processing category 132 is associated with a transaction, the user may be permitted to change or correct an activity associated with the transaction at any time. However, in case where the ‘with settlement’ processing category 131 is associated with a transaction, the user may only be allowed to change or correct activity data only after the contract settlement 122 and/or deal adjustment settlement 124 activities had occurred.

In an embodiment, the fiduciary deposit object 100 may also have flow categories 140 associated with the object representing cash flows between the insurance company and the counterparty. A flow category may store a cash flow amount and/or cash flow amount adjustment and a description or identifier of the cash flow amount used for proper accounting of the cash flow amount. Example of flows categories include investment increase or decrease 141, repayments 142, withdrawals 143, extensions 144, and corrections 145. In some embodiments, the flow categories may include additional information, such as whether the cash flow represents an inflow 146 to the insurance company or an outflow 146 to the counterparty. In some embodiments, one or more flows may be associated with each transaction in the business object.

In some embodiments, the fiduciary deposit object 100 may also have collateral associated with the underlying agreement upon which the agreement is based. Some insurance regulations may require the insurance company to maintain records relating to the collateral associated with the agreement. In some embodiments, a collateral category 150 may also be associated with a fiduciary deposit object 100 or a specific transaction or activity within the object. In an embodiment, the collateral category may store information, such as records relating to the collateral associated with a transaction based on accounting requirements. In some embodiments, the collateral categories 150 may include a description or name of the collateral 151; the quantity of collateral used 152; the cost, price or value of the collateral 153; the type of collateral used 154; and other information about the collateral, including information the insurance company is required to maintain.

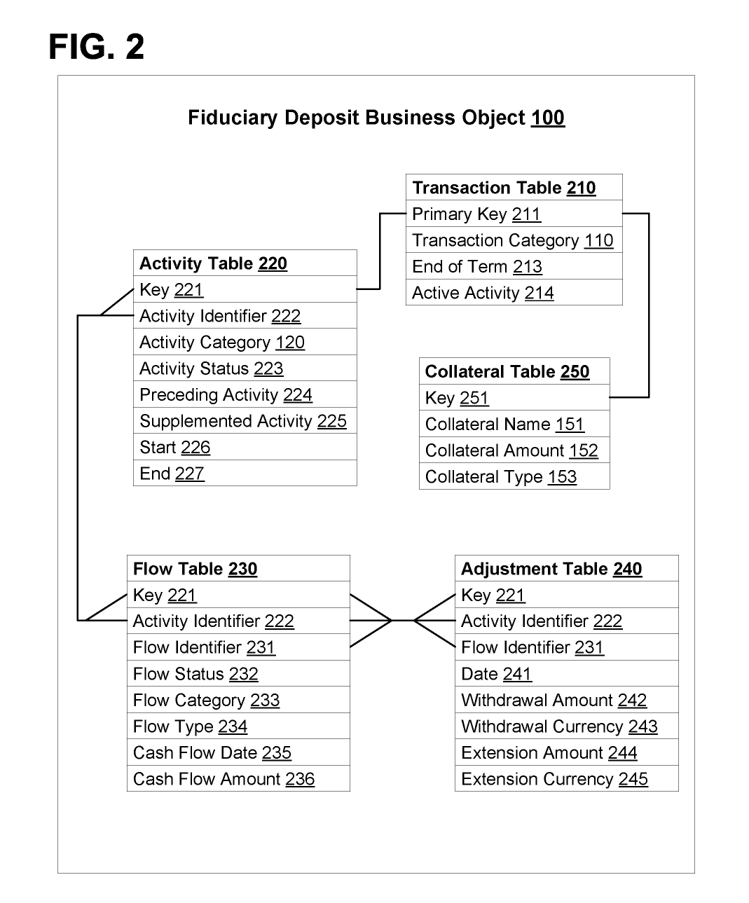

FIG. 2 shows a data structure of a fiduciary deposit business object 100 in an embodiment, including tables storing data associated with the business object. In an embodiment, fiduciary deposit object 100 may have a transaction table 210 storing a plurality of financial transactions, such as purchases 111 representing initial investments by the insurance company or installment repayments 112 representing monthly cash flows received by the insurance company. In an embodiment, each transaction in the transaction table 210 may have a primary key 211 to uniquely identify the transaction, a transaction category 110 identifying the type of transaction, an end of term 213 field to identify the end of the transaction, and an active activity 214 field to identify a current activity associated with the transaction.

In an embodiment, each transaction may be associated with one or more items of collateral. Details about each item of collateral, such a collateral description 151 or name, amount of collateral 152, value of the collateral 153, and type of collateral 154, may be stored in a collateral table 250. The collateral associated with a particular transaction may be linked to the transaction through a key 251 corresponding to the primary key 211.

In an embodiment, each transaction may have one or more activities associated with the transaction. Details of each activity may be stored in an activity table 220. Each activity may be associated with a transaction through a key 222 associated with the primary key 211 of the transaction. The activity table 220 may also contain fields for an activity identifier 222 to identify the particular activity, an activity category 120, a status of the activity 223, an identifier of the preceding activity 224, an identifier of another activity being supplemented 225 by the current activity, a start 226 of the current activity, and an end 227 of the current activity.

In an embodiment, each activity may have one or more cash flows associated with the activity. Details of each cash flow may be stored in a cash flow table 230. Each cash flow may be associated with an activity through the same key 221 and activity identifier 222 contained in the activity table 220. The cash flow table 230 may also contain fields for a cash flow identifier 231 to identify the particular cash flow, a status of the cash flow 232, a cash flow category 140, a type of cash flow 234, a date of the cash flow 235, and an amount of the cash flow 236.

In an embodiment, each cash flow may have one or more adjustments that are later made to cash flow. Details of each adjustment may be stored in an adjustment table 240. Each adjustment may be associated with a cash flow through the same key 221, activity identifier 222, and cash flow identifier 231 contained in the cash flow table 230. The adjustment table 240 may also contain fields for a date of the cash flow adjustment 241, a withdrawal amount 242 if an adjustment was made through a withdrawal, a currency 243 of the withdrawal amount, an extension amount 244 if the cash flow was extended beyond the intended expiration, and a currency 245 of the extension amount 244.

As discussed previously, the collateral table 250 may be used to store information about the collateral managed by the counterparty underlying the agreement between the insurance company and the counterparty. Data from the collateral table 250 may be used to comply with different reporting regulations, which may require the insurance company to account for the collateral managed by the counterparty. In some embodiments, data from the collateral 250 and other tables may be sent to an accounting system, which may then integrate the data into a financial statement or report in compliance with reporting requirements.

Fiduciary Deposit Business Object Management

In some embodiments, various accounting aspects of fiduciary deposit objects may be automatically managed. For example, when an insurance company and a counterparty agree that the counterparty will provide the insurance company with periodic payments over a fixed time in exchange for an initial payment, an embodiment may automatically parse each of the installment repayment cash flows from the counterparty to the insurance company into a redemption component and an interest income component, which may be calculated using amortization formulas.

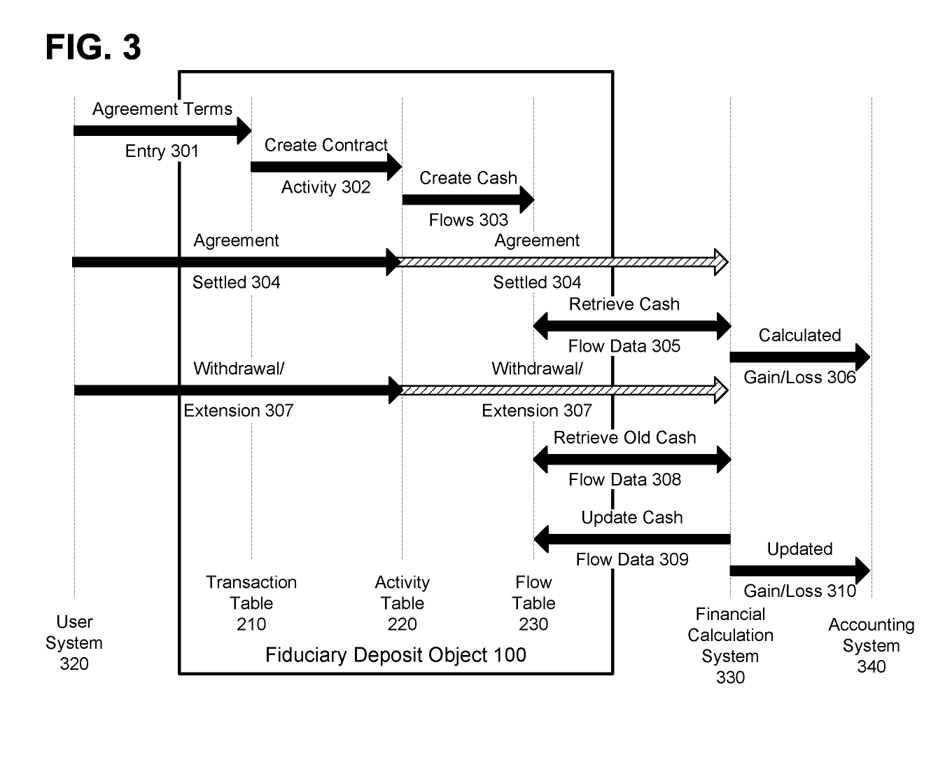

FIG. 3 shows the automated flow of data in an embodiment from the time different agreement related data is inputted at user system 320 to the time accounting related data is calculated at financial calculation system 330 and reported to an accounting system 340. The figure also shows the flow of data through various components of fiduciary deposit business object 100, including transaction tables 210, activity tables 220, and flow tables 230. In some embodiments, in addition to extracting cash flow data from flow tables 230, additional financial data may be extracted from collateral tables 250 to perform some financial calculations 330, including certain net present value calculations.

In step 301, terms of a fiduciary agreement may be identified at user system 320. In some embodiments, the identification may be done through a parsing unit that may parse the terms of an agreement stored in a file for keywords. Alternatively, the terms of the agreement may be stored in a form or in database fields which can then be electronically transferred to the fiduciary deposit object 100. Thus, any means of obtaining information, including, but not limited to, parsing data and extracting fields from a data source may be used.

Once the agreement terms have been identified, entries in the transaction table 210 and collateral table 250 may be generated using the identified agreement terms. For example, a purchase transaction and installment repayment transaction may be created from the inputted, parsed, or extracted agreement terms. Once the transactions are created, collateral table 250 entries containing the collateral information specified in and obtained from the agreement may be generated.

In step 302, a contract activity 121 may also be created and associated with transactions previously created after step 301. In step 303, cash flows relating to the contract activity 121 may be generated based on the extract cash flow terms contained in the agreement.

Sometime later, in step 304, the parties to the agreement may settle the agreement. Upon receiving the settlement notification, a new contract settlement activity 122 may be generated and stored in the activity table 220 of the fiduciary deposit object 100. In an embodiment, when a settlement activity is generated and stored in the activity table, a notification of the settlement may be sent to a calculation system 330 to begin financial calculations related to the new contract. At step 305, the calculation system 330 may retrieve cash flow information from the cash flow table 230. Once the pertinent cash flow information has been retrieved from cash flow table 230, financial calculations, such a calculated gain or loss, may be performed on the cash flow data. In step 306, the results of the financial calculations may be sent to an accounting system 340 for proper accounting.

Some time later, in step 307, there may be a withdrawal and/or extension of a fiduciary agreement. When such an event occurs, a withdrawal 143 and/or extension 144 activity may be generated and stored in activity table 220. In an embodiment, once the withdrawal 143 and/or extension 144 activity has been generated, data relating to the financial terms of the withdrawal 143/extension 144 may be sent to the calculation system 330. In step 308, the calculation system may retrieve the old cash flow data from cash flow table 230. In an embodiment, the calculation system may calculate new cash flow data based on the withdrawal 143/extension 144 terms, and then, in step 309, update the old cash flow data in the cash flow table 230 by generating appropriate adjustments in adjustment table 240. Financial calculation system 330 may also perform other financial calculations on the update cash flow data, including updated gain/loss calculations. In step 310, the results of these financial calculations may be sent to an accounting system 340 for proper accounting.

In some embodiments, when the terms of agreement between the insurance company and the fiduciary have been updated through an adjustment activity, the embodiments may continue to automatically process repayment cash flows as they are received by the insurance company into redemption and interest components using the updated data.

In some embodiments, a gain or loss may also be automatically calculated by comparing the amortized acquisition value based on the initial payment from insurance company to the counterparty to the net present value of the repayments from the counterparty to the insurance company.

In some embodiments, when a cash flow related component is a changed or corrected as of a specific date, a new cash flow calculation may be performed to account for this change. In this new calculation, an amortization amount may be calculated by subtracting the pre-specific date cash flows discounted by the pre-specific date yields from the post-specific date cash flows discounted by the post-specific date yields. In an embodiment, the calculated amortization amount may be added to the interest income component.

In some embodiments, when the terms of the agreement between the insurance company and the counterparty are adjusted through a deal adjustment activity resulting in a withdrawal or extension of cash flow on a specific date, the gain or loss may be automatically calculated based on the amount of the withdrawal or extension. To calculate the gain or loss, an embodiment may calculate the net monthly cash flow after completing the withdrawal or extension. In an embodiment, this may include recalculating the interest income component and the amortized amounts.

In an embodiment, the accrued income after completing the withdrawal or extension may by calculated by considering the amortized cost the day after the withdrawal or extension with the pre-withdrawal yield and considering the yield on the day after the withdrawal or extension as (1−AmortizedCostAtMonthEndBeforeWithdrawalOrExtension). In an embodiment, the gain or loss on a withdrawal or extension may be calculated by the following formula:

(Σ(Withdrawals·DiscountFactor))−MarketValueWithdrawal (1)

In some embodiments, a yield may be calculated based on the cash flows by setting the sum of the future cash flows equal to an initial investment amount. Each of the cash flows may be split into two parts: a redemption part and an interest part. In an embodiment, the yield, p_{eff}, for the cash flow may be calculated as solution for the following equation:

$$0 = {\sum }_{i = 0}^{N} {a}_{i} \cdot {( 1 + {p}_{eff} )}^{\frac{{t}_{0} - {t}_{i}}{365}} \qquad ( 2 )$$

Where i denotes the payment amount of flow i, and tᵢ is the payment date.

This equation (2) may also be restructured in order to separate the incoming and outgoing payments:

$$- {a}_{0} = {\sum }_{i = 1}^{N} {a}_{i} \cdot {( 1 + {p}_{eff} )}^{\frac{{t}_{0} - {t}_{i}}{365}} \qquad ( 3 )$$

Afterwards each flow may be discounted to the date of the last cash flow payment, with the yield resulting in a redemption component rᵢ for each flow which is given by:

$${r}_{i} = {a}_{i} \cdot {( 1 + {p}_{eff} )}^{\frac{{t}_{0} - {t}_{i}}{365}} ; {r}_{0} = {a}_{0} \qquad ( 4 )$$

Summing up each of these redemptions will give the initial investment amount.

In some embodiments, to perform the calculations needed to determine fair market value or net present value of the initial investment agreement, the value of the agreement between the insurance company and the counterpart and the value of the collateral underlying the agreement may be calculated separately and added together later.

Collateral in the form of bonds or similar securities are usually priced at market value whenever the security is liquid enough to have a representative public quotation. For collateral that is illiquid, a valuation model may be which takes into account not only market conditions, but also credit risk. General valuation techniques may be used when the illiquid collateral has a common cash flow pattern or at most, one of the commonly used fixed income embedded derivatives, such as caps, floors, put, or calls.

The agreement itself may be valuated independent of the collateral using cash flow discounting of both the liabilities and the collateral flows without quantifying any credit risk, such as by using the Euro-Constant Maturity Swap flat curve. The net present value of the entire agreement is the sum of these two amounts.

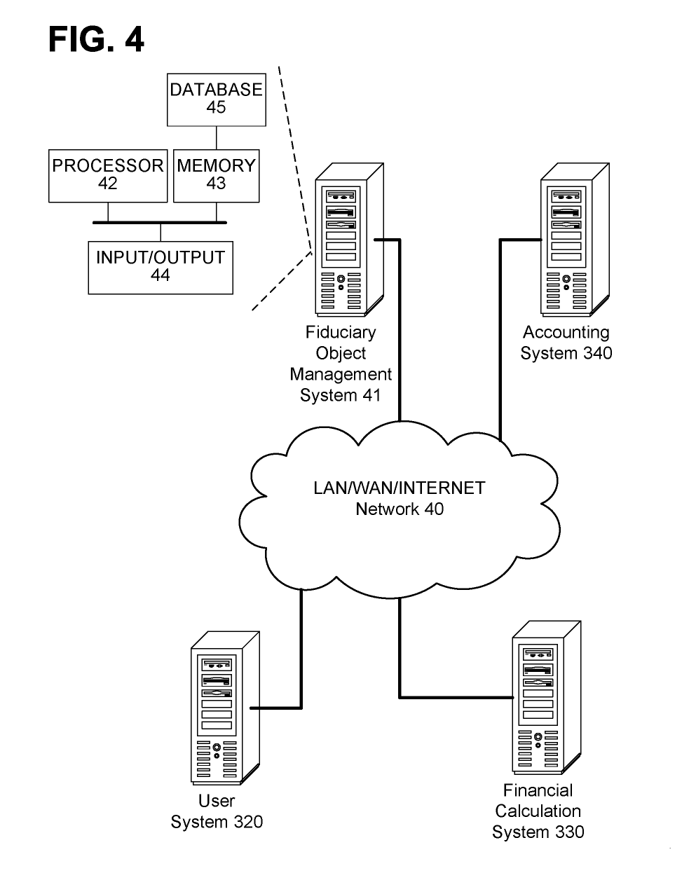

FIG. 4 shows an embodiment of an enterprise resource planning system. In this embodiment, the fiduciary object management system 41, accounting system 46, user system 47, and calculation system 48 make up the overall enterprise resource planning system, and are all interconnected through network 40. Each of the systems in FIG. 4 may contain a processor 42, memory 43 containing a database 45, and an input/output interface 44, all of which are interconnected via a system bus. In various embodiments, these system may have an architecture with modular hardware and/or software systems that include additional and/or different systems that communicate through one or more networks. The modular design allows a business to add, exchange, and upgrade systems, including, in some embodiments using systems from different vendors. Because of the highly customized nature of enterprise resource planning systems, different embodiments may have different types, quantities, and configurations of systems depending on the environment and organizational demands.

In an embodiment, memory 43 may contain different components for retrieving, presenting, changing, and saving data. Memory 43 may include a variety of memory devices, for example, Dynamic Random Access Memory (DRAM), Static RAM (SRAM), flash memory, cache memory, and other memory devices. Additionally, for example, memory 43 and processor(s) 42 may be distributed across several different computers that collectively comprise a system. The memory 43 and/or database 45 may be used in the fiduciary object management system 41 to store one or more fiduciary deposit business objects 100.

Processor 42 may perform computation and control functions of a system and comprises a suitable central processing unit (CPU). Processor 42 may comprise a single integrated circuit, such as a microprocessor, or may comprise any suitable number of integrated circuit devices and/or circuit boards working in cooperation to accomplish the functions of a processor. Processor 42 may execute computer programs, such as object-oriented computer programs, within memory 43. In some embodiments, the processor 42 in the fiduciary object management system 41 may be used to perform gain/loss, net present value, and other financial calculations 330 on data stored in fiduciary deposit business objects 100. In other embodiments, one or more processors 42 in calculation system 48, which may specially configured to enable high speed financial calculations 330, may be used to perform the financial calculations 330.

Note that while embodiments of the present invention are described in the context of fully functional computer systems, those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A fiduciary object management system comprising a processor, the processor operative to:
receive a plurality of fiduciary cash flow instrument agreement terms identifying a financial transaction of the cash flow instrument, a collateral supporting the financial transaction, an action taken on the agreement terms of the financial transaction, and a cash flow term relating to the action taken;
store the plurality of terms in a fiduciary deposit business object;
responsive to a subsequent settlement of the terms of the fiduciary cash flow instrument, store the settlement of the agreement terms in the fiduciary deposit business object, the storage of the settlement of the agreement terms triggering the processor to:
retrieve monetary terms from the fiduciary deposit business object;
perform a gain/loss calculation on the fiduciary cash flow instrument using the retrieved monetary terms; and
send a result of the calculation to an accounting system; and
responsive to a subsequent withdrawal/extension of the fiduciary cash flow instrument, store a term of the withdrawal/extension in the fiduciary deposit business object, the storage of the term of the withdrawal/extension triggering the processor to:
retrieve the monetary terms from the fiduciary deposit business object;
compare the retrieved monetary terms to the stored term of the withdrawal/extension;
perform a gain/loss calculation on the fiduciary cash flow instrument using the retrieved monetary terms, the stored withdrawal/extension term, and the comparison of the retrieved monetary terms to the stored term; and
send a result of the calculation to the accounting system.

2. The fiduciary object management system of claim 1, where the financial transaction is stored in a transaction table of the fiduciary deposit business object.

3. The fiduciary object management system of claim 2, where each action taken on the agreement terms of the financial transaction is stored in an activity table linked to the transaction table.

4. The fiduciary object management system of claim 3, where each cash flow term relating to each action taken is stored in a cash flow table linked to the corresponding activity table.

5. The fiduciary object management system of claim 4, where the cash flow terms include at least one monetary term.

6. The fiduciary object management system of claim 5, where at least one of the monetary terms includes either a monthly cash flow to be received or a principal paid.

7. The fiduciary object management system of claim 6, where a withdrawal/extension amount is stored in an adjustment table and linked to the corresponding cash flow terms in the cash flow table.

8. The fiduciary object management system of claim 5, where subsequent changes to the monetary terms are stored in an additional cash flow table entries linked to the corresponding activity in the activity table.

9. The fiduciary object management system of claim 8, where the monetary terms retrieved by the processor include at least one most recently added cash flow entry in a most recently added activity of at least one transaction.

10. The fiduciary object management system of claim 3, where subsequent changes to the activity are stored in additional activity table entries linked to the transaction.

11. The fiduciary object management system of claim 8, where the monetary terms retrieved by the processor further includes all cash flow entries relating to purchase or installment repayment transactions.

12. The fiduciary object management system of claim 1, where the storage of the settlement of the agreement terms triggers the processor to notify a financial calculation system, the financial calculation system:
retrieving the monetary terms from the fiduciary deposit business object;
performing the gain/loss calculation on the fiduciary cash flow instrument using the retrieved monetary terms; and
sending the result of the calculation to the accounting system; and
where the storage of the term of the withdrawal/extension triggers the processor to notify the financial calculation system, the financial calculation system:
retrieving the monetary terms from the fiduciary deposit business object;
comparing the retrieved monetary terms to the stored term of the withdrawal/extension;
performing the gain/loss calculation on the fiduciary cash flow instrument using the retrieved monetary terms, the stored withdrawal/extension term, and the comparison of the retrieved monetary terms to the stored term; and
sending the result of the calculation to the accounting system.

13. The fiduciary object management system of claim 1, where data identifying the collateral supporting the cash flow instrument is stored in a collateral table, the data in the collateral table is linked to the transaction through the first key, and the data in the collateral table is sent to the accounting system with the results of calculations involving the linked transaction.

14. The fiduciary object management system of claim 3, where:
the term of the withdrawal/extension is stored in an adjustment table, the adjustment table linked to the cash flow entry associated with the withdrawal/extension term through a third key;
subsequent changes to the withdrawal/extension amount are recorded in an additional adjustment table entries linked to the cash flow entry through the third key; and
the monetary terms retrieved by the processor include the withdrawal/extension term and all subsequent changes, the withdrawal/extension term and all subsequent changes used during the gain/loss calculation.

15. A computer-implemented method comprising steps performed by a processor, the processor operative to:
receive a plurality of fiduciary cash flow instrument agreement terms identifying a financial transaction of the cash flow instrument, a collateral supporting the financial transaction, an action taken on the agreement terms of the financial transaction, and a cash flow term relating to the action taken;
store the plurality of terms in a fiduciary deposit business object;
responsive to a subsequent settlement of the terms of the fiduciary cash flow instrument, store the settlement of the agreement terms in the fiduciary deposit business object, the storage of the settlement of the agreement terms triggering the processor to:
retrieve monetary terms from the fiduciary deposit business object;
perform a gain/loss calculation on the fiduciary cash flow instrument using the retrieved monetary terms; and
send a result of the calculation to an accounting system; and
responsive to a subsequent withdrawal/extension of the fiduciary cash flow instrument, store a term of the withdrawal/extension in the fiduciary deposit business object, the storage of the term of the withdrawal/extension triggering the processor to:
retrieve the monetary terms from the fiduciary deposit business object;
compare the retrieved monetary terms to the stored term of the withdrawal/extension;
perform a gain/loss calculation on the fiduciary cash flow instrument using the retrieved monetary terms, the stored withdrawal/extension term, and the comparison of the retrieved monetary terms to the stored term; and
send a result of the calculation to the accounting system.

16. The computer-implemented method of claim 15, where the financial transaction is stored in a transaction table of the fiduciary deposit business object.

17. The computer-implemented method of claim 16, where each action taken on the agreement terms of the financial transaction is stored in an activity table linked to the transaction table.

18. The computer-implemented method of claim 17, where each cash flow term relating to each action taken is stored in a cash flow table linked to the corresponding activity table.

19. The computer-implemented method of claim 18, where a withdrawal/extension amount is stored in an adjustment table and linked to the corresponding cash flow terms in the cash flow table.

20. An article of manufacture comprising signal bearing media storing instructions that, when executed by a processor, cause the processor to:
receive a plurality of fiduciary cash flow instrument agreement terms identifying a financial transaction of the cash flow instrument, a collateral supporting the financial transaction, an action taken on the agreement terms of the financial transaction, and a cash flow term relating to the action taken;
store the plurality of terms in a fiduciary deposit business object;
responsive to a subsequent settlement of the terms of the fiduciary cash flow instrument, store the settlement of the agreement terms in the fiduciary deposit business object, the storage of the settlement of the agreement terms triggering the processor to:
retrieve monetary terms from the fiduciary deposit business object;
perform a gain/loss calculation on the fiduciary cash flow instrument using the retrieved monetary terms; and
send a result of the calculation to an accounting system; and
responsive to a subsequent withdrawal/extension of the fiduciary cash flow instrument, store a term of the withdrawal/extension in the fiduciary deposit business object, the storage of the term of the withdrawal/extension triggering the processor to:
retrieve the monetary terms from the fiduciary deposit business object;
compare the retrieved monetary terms to the stored term of the withdrawal/extension;
perform a gain/loss calculation on the fiduciary cash flow instrument using the retrieved monetary terms, the stored withdrawal/extension term, and the comparison of the retrieved monetary terms to the stored term; and
send a result of the calculation to the accounting system.
